(19) United States
(12) Patent Application Publication
(10) Pub. No.: US 2015/0149128 A1
(43) Pub. Date: May 28, 2015

(54) SYSTEMS AND METHODS FOR ANALYZING MODEL PARAMETERS OF ELECTRICAL POWER SYSTEMS USING TRAJECTORY SENSITIVITIES

(71) Applicant: General Electric Company, Schenectady, NY (US)

(72) Inventors: Chaitanya Ashok Baone, Niskayuna, NY (US); JongMin Lim, Madison, WI (US); Sumit Bose, Niskayuna, NY (US)

(73) Assignee: General Electric Company, Schenectady, NY (US)

(21) Appl. No.: 14/087,890

(22) Filed: Nov. 22, 2013

(51) Int. Cl. G06F 17/50

(52) U.S. Cl. CPC G06F 17/5009
USPC 703/2

(57) ABSTRACT

A computer system for analyzing system parameters of a simulation model for an electrical power system includes a processor programmed to generate a trajectory sensitivities matrix for the electrical power system using a dynamic model of the electrical power system that includes a plurality of system parameters, and to identify a plurality of well-conditioned parameters for a first disturbance from the plurality of system parameters based at least in part on the trajectory sensitivities matrix. The processor is also programmed to generate a first pair of well-conditioned parameters from the plurality of well-conditioned parameters. The first pair includes a first parameter and a second parameter. The processor is further programmed to compute a dependence value between the first parameter and the second parameter, and to provide an indicator of dependence between the first parameter and the second parameter using the dependence value.

### BACKGROUND

The present disclosure relates generally to analyzing electrical power systems and, more specifically, to systems and methods for analyzing model parameters for electrical power transmission systems using a trajectory sensitivities approach.

Some known electrical power systems are analyzed using dynamic simulations of the power system. Utility operators may rely on such simulations to make operational and planning decisions. In some dynamic simulations, a mathematical model of differential algebraic equations may be used. This model describes the behavior of system components, such as power generators. The model may include various model parameters that represent tunable characteristics of the model and influence the response of the model. In some known systems, models may be gauged based on their accuracy against actual measurements from the transmission system. An ideal model is one in which the model's output for a given disturbance matches what actually happens in the real transmission system during a real disturbance. Thus, some model designers may seek to tune an existing model to better match what is witnessed on the actual transmission system during a disturbance. As such, model parameter tuning may be viewed as an optimization problem whose objective is to minimize the difference between model response and measured quantity.

To properly tune a model for a complex power system, identification of influential model parameters, i.e., model parameter identification, and estimation of those parameters may be required. Successful model parameter identification and/or estimation using measurements may depend on the nature of influence of model parameters on measured quantities. If a parameter has a very weak effect on the measured output, successful estimation of such a parameter is unlikely because its effect may not be accurately quantified. If the effects of certain parameters on measured output are nearly linearly dependent, successful estimation of such parameters is unlikely because the individual parameter effects may not be distinguishable. The presence of parameters with weak and/or nearly linearly dependent effects is manifested by non-unique solutions to the estimation problem for different initial parameter values in the optimization problem of minimizing the difference between measured quantity and model output. It may be beneficial to identify sets of parameters with strong and linearly independent effects across qualitatively different disturbances, and to identify the “best” disturbances to use for model tuning.

### BRIEF DESCRIPTION

In one aspect, a computer system for analyzing system parameters of a simulation model for an electrical power system is provided. The computer system includes a processor programmed to generate a trajectory sensitivities matrix for the electrical power system using at least a dynamic model of the electrical power system that includes a plurality of system parameters. The processor is also programmed to identify a plurality of well-conditioned parameters for a first disturbance from the plurality of system parameters based at least in part on the trajectory sensitivities matrix. The processor is further programmed to generate a first pair of well-conditioned parameters from the plurality of well-conditioned parameters. The first pair includes a first parameter and a second parameter. The processor is also programmed to compute a dependence value between the first parameter and the second parameter. The processor is further programmed to provide an indicator of dependence between the first parameter and the second parameter using the dependence value.

In another aspect, at least one non-transitory computer-readable storage media having computer-executable instructions embodied thereon is provided. When executed by at least one processor, the computer-executable instructions cause the processor to generate a trajectory sensitivities matrix for an electrical power system using at least a dynamic model of the electrical power system that includes a plurality of system parameters. The computer-executable instructions also cause the processor to identify a plurality of well-conditioned parameters for a first disturbance from the plurality of system parameters based at least in part on the trajectory sensitivities matrix. The computer-executable instructions further cause the processor to generate a first pair of well-conditioned parameters from the plurality of well-conditioned parameters. The first pair includes a first parameter and a second parameter. The computer-executable instructions also cause the processor to compute a dependence value between the first parameter and the second parameter. The computer-executable instructions further cause the processor to provide an indicator of dependence between the first parameter and the second parameter using the dependence value.

In yet another aspect, a computer-based method for analyzing system parameters of a simulation model for an electrical power system is provided. The method uses a computing device including at least one processor. The method includes generating a trajectory sensitivities matrix for the electrical power system using at least a dynamic model of the electrical power system that includes a plurality of system parameters. The method also includes identifying, by the at least one processor, a plurality of well-conditioned parameters for a first disturbance from the plurality of system parameters based at least in part on the trajectory sensitivities matrix. The method further includes generating, by the at least one processor, a first pair of well-conditioned parameters from the plurality of well-conditioned parameters. The first pair includes a first parameter and a second parameter. The method also includes computing, by the at least one processor, a dependence value between the first parameter and the second parameter. The method further includes providing an indicator of dependence between the first parameter and the second parameter using the dependence value.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a general schematic diagram of both an exemplary transmission network and an exemplary electrical power distribution system;

FIG. 2 is a block diagram of an exemplary PDC system used to analyze the electrical power distribution network shown in FIG. 1 and, more specifically, the transmission grid shown in FIG. 1;

FIG. 3 is a flow chart of an exemplary method for analyzing model parameters of the transmission network shown in FIG. 1 using the PDC system shown in FIG. 2;

FIG. 4 is a table of exemplary simulation results using the analysis method shown in FIG. 3 and the computing system shown in FIG. 2;

FIG. 5 is a table showing algorithm validation results for disturbance D1 shown in FIG. 4;

FIG. 6 is an exemplary graph showing a comparison of the norm of difference between active powers when altering independent variables and the norm of difference between active powers when altering dependent variables under disturbance D1 as shown in Table 1;

FIG. 7 is a flow chart of an exemplary method for analyzing system parameters of a simulation model for the transmission system shown in FIG. 1 using the computing system shown in FIG. 2; and

FIG. 8 illustrates an example configuration of a database within a computing device, along with other related computing components, that may be used during analysis of model parameters as described herein.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital media, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

As used herein, the term “operator” includes any person in any capacity associated with operating and maintaining electric distribution system, including, without limitation, users of the systems described herein, shift operations personnel, maintenance technicians, and system supervisors.

The methods and systems described herein provide a trajectory sensitivity analysis-based approach to identify a set of model parameters that are well-conditioned, i.e., with strong effects, and are linearly independent. Some of the exemplary embodiments described herein include a “preprocessor” style method for identifying influential disturbances and/or parameters that facilitate improved model tuning A historical database of disturbances is analyzed in order to determine a subset of disturbances and parameters that enhance model tuning. The historical database has many available disturbances and associated data that have been collected over time, and which may result in qualitatively different model responses. As such, some types of disturbances may provide improved avenues for model tuning.

Further, in some embodiments, the system ranks the model parameters by their impact on model behavior. A set of influential model parameters are ranked, and may be subsequently used for parameter estimation algorithms needing to tune a small set of parameters. The model parameter ranking provides a list of the most relevant parameters impacting the model's behavior, i.e., benefiting the optimization problem by prioritizing which parameters to tune, since there may be a significant cost/time associated with running such algorithms on large scale systems. This may be beneficial in large scale dynamic models of power systems, where arbitrarily attempting to tune parameters in order to meet the objective of matching model response with measurement data may be computationally challenging. Such an approach enables targeting an influential subset of parameters in order to achieve significant variation in model response.

Moreover, in some embodiments, a subset of disturbance conditions may also be identified that facilitates successful parameter estimation. Such a subset may include the disturbances that result in a high number of parameters that have a significant impact on the measured quantity, as well as have independent effects.

In addition, these systems and methods identify key data samples, for a given disturbance, that may be used in the parameter estimation process. For example, historical data for a disturbance may include streams of PMU data collected over many days. If model analysis were to be conducted with all of this data, the process may be highly inefficient and computationally costly, as the data may contain redundant information that adds little value to the optimization problem. Instead, the systems and methods described herein decompose the data in such a way as to identify key directions in which most of the useful information exists. Such information facilitates a numerically efficient estimation process, particularly for systems with a large number of parameters.

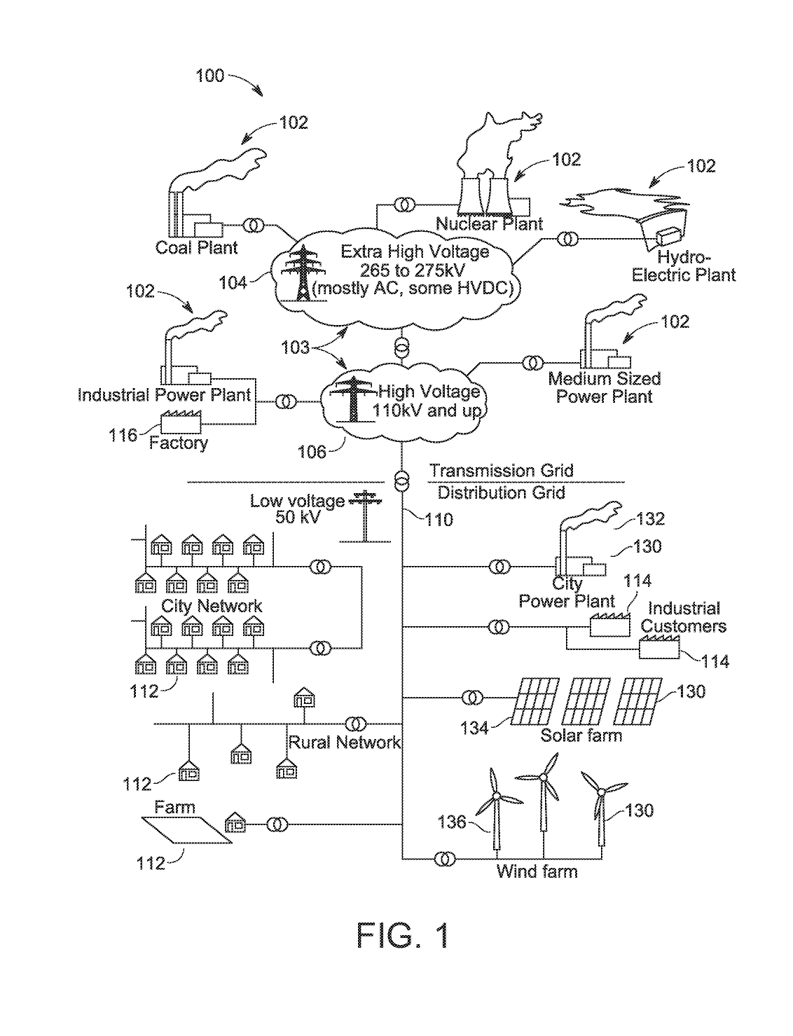

FIG. 1 is a general schematic diagram of an exemplary electrical power network 100. Electrical power network 100 typically includes power plants 102 outputting power through a transmission grid 103, which includes an extra high voltage transmission grid 104 and a high voltage transmission grid 106 through which power is transmitted to an exemplary electrical power distribution system 110. Electrical power network 100 may include, without limitation, any number, type and configuration of extra high voltage transmission grids 104, high voltage transmission grids 106, and electrical power distribution systems 110, as well as any number of consumers within electrical power distribution system 110, high voltage transmission grid 106, e.g., greater than 110-265 kilovolts (kV), and extra high voltage grid 104, e.g., greater than 265 kV.

Electrical power distribution system 110 includes low wattage consumers 112 and industrial medium wattage consumers 114. Electrical power distribution system 110 also includes distributed generators 130, including a city power plant 132, a solar farm 134, and a wind farm 136. While electrical power distribution system 110 is shown with an exemplary number and type of distributed generators 130, electrical power distribution system 110 may include any number and type of distributed generators 130, including, without limitation, diesel generators, micro-turbines, solar collector arrays, photo-voltaic arrays, and wind turbines.

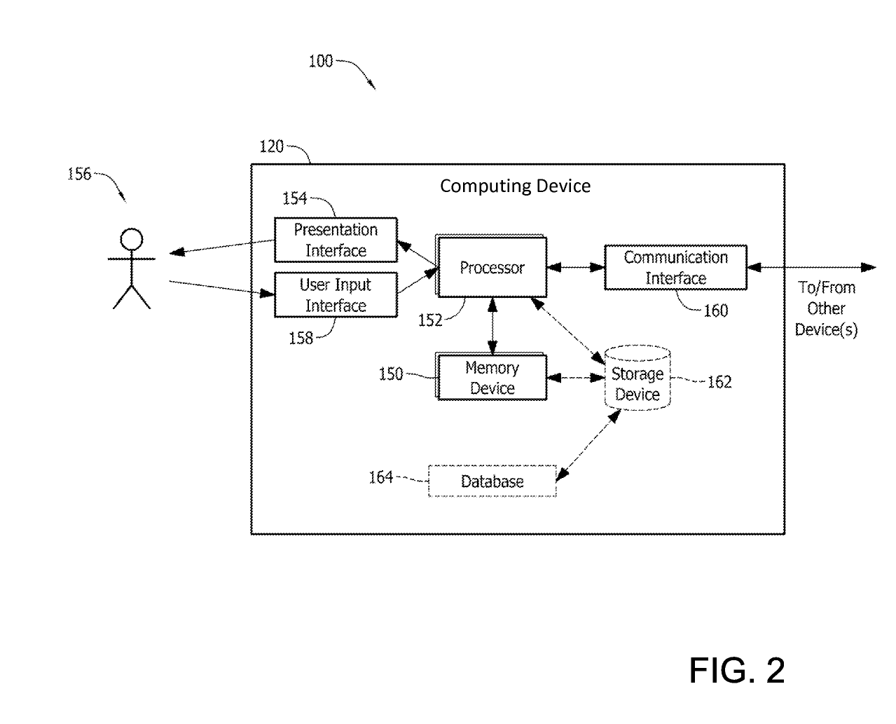

FIG. 2 is a block diagram of an exemplary computing system 120 used to analyze electrical power network 100 (shown in FIG. 1) and, more specifically, transmission grid 103 (shown in FIG. 1). Alternatively, any computer architecture that enables operation of computing system 120 as described herein may be used. Computing system 120 facilitates collecting, storing, analyzing, displaying, and transmitting data and operational commands associated with configuration, operation, monitoring and maintenance of components in transmission grid 103.

Also, in the exemplary embodiment, computing system 120 includes a memory device 150 and a processor 152 operatively coupled to memory device 150 for executing instructions. In some embodiments, executable instructions are stored in memory device 150. Computing system 120 is configurable to perform one or more operations described herein by programming processor 152. For example, processor 152 may be programmed by encoding an operation as one or more executable instructions and providing the executable instructions in memory device 150. Processor 152 may include one or more processing units, e.g., without limitation, in a multi-core configuration.

Further, in the exemplary embodiment, memory device 150 is one or more devices that enable storage and retrieval of information such as executable instructions and/or other data. Memory device 150 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Also, in the exemplary embodiment, memory device 150 may be configured to store a variety of operational data associated with components and operational data transmitted from PMU's (not shown in FIG. 1) associated with components of transmission grid 103 including, without limitation, voltage and current at points of interest in transmission grid 103, magnitude and phase angles, i.e., phasors, of the sine waves found in electricity, and time synchronization data.

In some embodiments, computing system 120 includes a presentation interface 154 coupled to processor 152. Presentation interface 154 presents information, such as a user interface and/or an alarm, to a user 156. For example, presentation interface 154 may include a display adapter (not shown) that may be coupled to a display device (not shown), such as a cathode ray tube (CRT), a liquid crystal display (LCD), an organic LED (OLED) display, and/or a hand-held device with a display. In some embodiments, presentation interface 154 includes one or more display devices. In addition, or alternatively, presentation interface 154 may include an audio output device (not shown), e.g., an audio adapter and/or a speaker.

In some embodiments, computing system 120 includes a user input interface 158. In the exemplary embodiment, user input interface 158 is coupled to processor 152 and receives input from user 156. User input interface 158 may include, for example, a keyboard, a pointing device, a mouse, a stylus, and/or a touch sensitive panel, e.g., a touch pad or a touch screen. A single component, such as a touch screen, may function as both a display device of presentation interface 154 and user input interface 158.

Further, a communication interface 160 is coupled to processor 152 and is configured to be coupled in communication with one or more other devices such as, without limitation, components in transmission grid 103, another computing system 120, one or more PMU's (not shown), and any device capable of accessing computing system 120 including, without limitation, a portable laptop computer, a personal digital assistant (PDA), and a smart phone. Communication interface 160 may include, without limitation, a wired network adapter, a wireless network adapter, a mobile telecommunications adapter, a serial communication adapter, and/or a parallel communication adapter. Communication interface 160 may receive data from and/or transmit data to one or more remote devices. Computing system 120 may be web-enabled for remote communications, for example, with a remote desktop computer (not shown).

Also, presentation interface 154 and/or communication interface 160 are both capable of providing information suitable for use with the methods described herein, e.g., to user 156 or another device. Accordingly, presentation interface 154 and communication interface 160 may be referred to as output devices. Similarly, user input interface 158 and communication interface 160 are capable of receiving information suitable for use with the methods described herein and may be referred to as input devices.

Further, processor 152 and/or memory device 150 may also be operatively coupled to a storage device 162. Storage device 162 is any computer-operated hardware suitable for storing and/or retrieving data, such as, but not limited to, data associated with a database 164. In the exemplary embodiment, storage device 162 is integrated in computing system 120. For example, computing system 120 may include one or more hard disk drives as storage device 162. Moreover, for example, storage device 162 may include multiple storage units such as hard disks and/or solid state disks in a redundant array of inexpensive disks (RAID) configuration. Storage device 162 may include a storage area network (SAN), a network attached storage (NAS) system, and/or cloud-based storage. Alternatively, storage device 162 is external to computing system 120 and may be accessed by a storage interface (not shown).

Moreover, in the exemplary embodiment, database 164 contains a variety of static and dynamic operational data associated with components, some of which may be transmitted from PMU's (not shown in FIG. 2) associated with components in transmission grid 103 including, without limitation, voltage and current values at points of interest in transmission grid 103, magnitude and phase angles of the sine waves found in electricity, and time synchronization data.

The embodiments illustrated and described herein as well as embodiments not specifically described herein but within the scope of aspects of the disclosure, constitute exemplary means for recording, storing, retrieving, and displaying operational data associated with an electrical power transmission system. For example, computing system 120, and any other similar computer device added thereto or included within, when integrated together, include sufficient computer-readable storage media that is/are programmed with sufficient computer-executable instructions to execute processes and techniques with a processor as described herein. Specifically, computing system 120 and any other similar computer device added thereto or included within, when integrated together, constitute an exemplary means for recording, storing, retrieving, and displaying operational data associated with transmission grid 103.

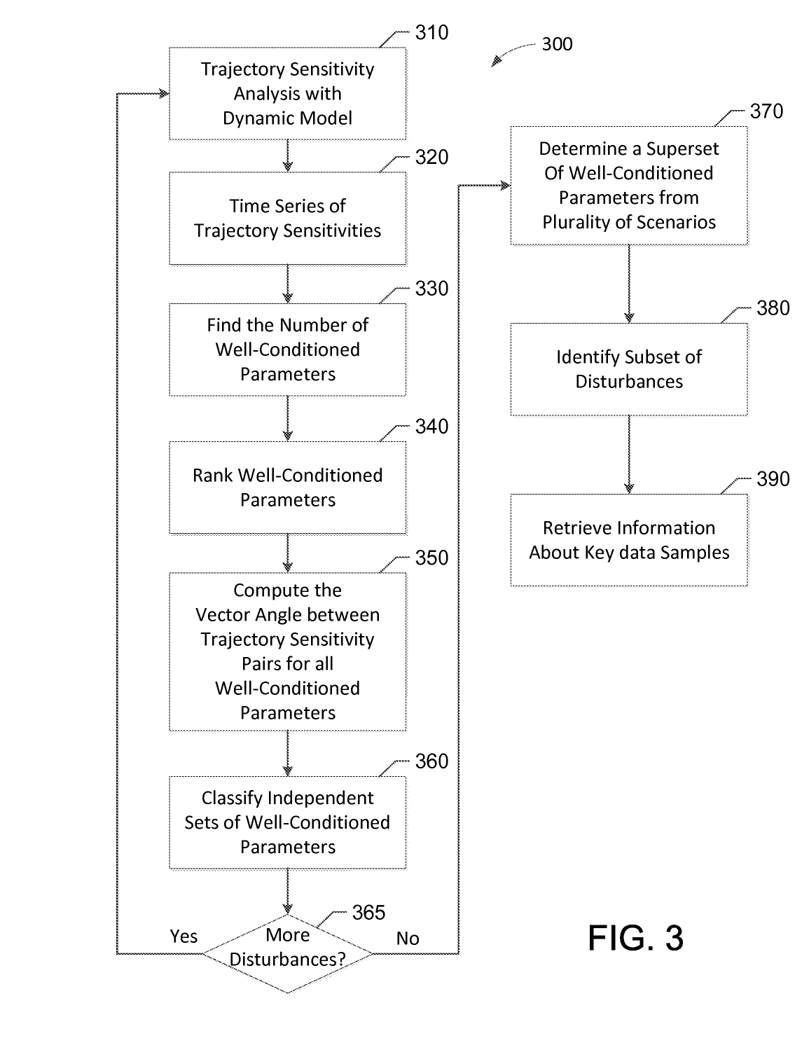

FIG. 3 is a flow chart of an exemplary method 300 for analyzing model parameters of transmission grid 103 (shown in FIG. 1) using computing system 120 (shown in FIG. 2). In the exemplary embodiment, method 300 operates on a mathematical model of an electric power transmission system, such as transmission grid 103. In some embodiments, a set of differential algebraic equations (DAE) describe the dynamic behavior of the transmission system. For example, the dynamic behavior of transmission system 103 is modeled using the set of DAEs:

\dot{x}=f(x,y,θ), (1)

and

0=g(x,y,θ), (2)

where x is a vector of state variables associated with the dynamic states of generators, loads, and other system components, y is a vector of algebraic variables associated with steady-state variables such as voltage phasor magnitudes and angles, and θ are the parameters of the model, such as, for example, motor inertia or resistance.

In step 310, trajectory sensitivity analysis is performed using the dynamic model. Trajectory sensitivities (TS) quantify variations in system variables due to changes in the system parameters θ. In the exemplary embodiment, a set of TS equations is formed for the model:

$$\begin{matrix}{\dot{S}}_{x} = \frac{\partial f}{\partial x} {S}_{x} + \frac{\partial f}{\partial y} {S}_{y} + \frac{\partial f}{\partial θ} , \\ and & ( 3 ) \\ 0 = \frac{\partial g}{\partial x} {S}_{x} + \frac{\partial g}{\partial y} {S}_{y} + \frac{\partial g}{\partial θ} , \\ where , & ( 4 ) \\ {S}_{x} = \frac{\partial x}{\partial θ} , \\ and \\ {S}_{y} = \frac{\partial y}{\partial θ} . & ( 5 )\end{matrix}$$

TS may give information on conditioning of parameters for a given disturbance, such as a particular network segmentation, and for a measurement signal. The term “poorly-conditioned parameters” refers generally to those parameters of the system model that do not significantly impact the model response. The term “well-conditioned parameters” refers generally to those parameters of the system model that do significantly impact the measured quantity. Prioritization among the model parameters that have strong impacts on model response may be desirable in tuning the model to reduce the error between model response and actual data. If a parameter has a strong effect on model output, i.e., if it is a well-conditioned parameter, estimation of such a parameter is more feasible because its effect may be quantified. On the other hand, a parameter with a weak effect on model response, i.e., a poorly-conditioned parameter, may be more difficult to estimate because its variation may not lead to any change in model output. Further, it may also be desirable to identify qualitative impacts of model response from the parameter modifications. If effects of certain parameters on measured output are significantly dependent, such as nearly linearly dependent, successful estimation of such parameters is less feasible because the individual parameter effects may not be distinguishable.

In the exemplary embodiment, for a given disturbance, trajectory sensitivity analysis (TSA) of the model response to all the model parameters is conducted with nominal values of the parameters θ. At step 320, a time series of trajectory sensitivities is constructed. An m by n matrix S_{y} is formed:

$$\begin{matrix}{S}_{y} = {[ \frac{\partial y}{\partial θ} ]}_{m \times n} \\ = [ \begin{matrix}\frac{\partial y ( {t}_{1} )}{\partial {θ}_{1}} & \frac{\partial y ( {t}_{2} )}{\partial {θ}_{1}} & … & \frac{\partial y ( {t}_{n} )}{\partial {θ}_{1}} \\ \frac{\partial y ( {t}_{1} )}{\partial {θ}_{2}} & \frac{\partial y ( {t}_{2} )}{\partial {θ}_{2}} & … & \frac{\partial y ( {t}_{n} )}{\partial {θ}_{2}} \\ ⋮ & ⋮ & ⋮ & ⋮ \\ \frac{\partial y ( {t}_{1} )}{\partial {θ}_{m}} & \frac{\partial y ( {t}_{2} )}{\partial {θ}_{m}} & … & \frac{\partial y ( {t}_{n} )}{\partial {θ}_{m}}\end{matrix} ] \\ = [ \begin{matrix}{S}_{1} \\ {S}_{2} \\ ⋮ \\ {S}_{m}\end{matrix} ] ,\end{matrix} \qquad ( 6 )$$

where m is the number of parameters in the system model, and n is a number of time samples. S₁, S₂, . . . , Sₘ are sensitivity vectors for each respective parameter, i.e., each row of S_{y}, such as row x, is a sensitivity vector for that particular parameter θₓ, and each column is a simulated time sample between time samples t₁ and tₙ.

In the exemplary embodiment, the information for prioritization and classification of parameters may then be extracted from the data matrix using singular value decomposition (SVD) and vector angle computations. The known process of singular value decomposition (SVD) is a mathematical tool for analysis of matrix structure and characteristics that may be used in signal processing. Generally, SVD performs a factorization of a matrix A into three component matrices, U, S, and V^{T}:

A=USV^{T}, (7)

where A is an m-by-n matrix of real-valued entries, U is a unitary m-by-m matrix whose column vectors are referred to as left singular vectors, V is an n-by-n unitary matrix whose rows are referred to as right singular vectors, and S is an m-by-n matrix in which an upper-left square block has diagonal entries referred to as singular values. The specific analytical uses of each of the U, S, and V matrices are described in greater detail herein. SVD factorization, generally, offers geometric data into the behavior of the matrix as a linear operator. In geometric terms, the singular values may be viewed as identifying the “gain” of the linear operator, acting on orthogonal axes in the domain, i.e., “input”, determined by the right singular vectors, and reflected in the range, i.e., “output”, along the orthogonal axes determined by the left singular vectors. In other words, A maps a unit sphere in n dimension space to an ellipsoid in m dimension space with the directions of axes of the ellipsoid indicated by left singular vectors and axes lengths given by singular values. SVD provides a way to reduce high dimensions of data to a lower dimensional space, and may evince hidden and simplified structure in large data sets.

At step 330, in the exemplary embodiment, SVD is performed on the matrix S_{y} for a given disturbance. More particularly, for the application of dynamic power system models, matrix A, i.e., the S_{y} matrix, is made of the trajectory sensitivities, where the number of rows, m, equals the number of parameters, and the number of columns, n, equals the number of data samples. Each row corresponds to the sensitivity of model response to a particular parameter. A number p of well-conditioned parameters are identified in terms of sensitivities by identifying a subset of p singular values, i.e., σ_{f} to σₚ, from the S matrix after SVD decomposition of S_{y} that are much larger than the rest of the parameters with their associated sensitivities. In some embodiments, a pre-defined threshold value is used to delineate well-conditioned parameters from poorly-conditioned parameters based on the magnitude of the singular values, such as, for example, a singular value threshold of 0.01. In other embodiments, ratios and/or differences between successive singular values are computed and examined. For example, the difference between successive singular values may be compared against a threshold value for determination as to whether to include the next singular value in the subset p. In other words, a clear change in singular values may be used to delineate well-conditioned from poorly conditioned parameters.

At step 340, in some embodiments, ranking of the p singular values is performed using each of the p singular values of the well-conditioned parameters, along with their corresponding left singular vectors. During SVD decomposition of matrix S_{y}, the S matrix identifies the singular values of matrix S_{y}. Each singular value, σᵢ, of the well-conditioned parameters identifies a row index number, i, corresponding to the row of the Σ matrix in which it appears. That particular singular value σᵢ also has a corresponding left singular vector, uᵢ, that is identified as one of the columns of the U matrix from the SVD decomposition of S_{y}. More particularly, the left singular vector uᵢ associated with singular value σᵢ is the i-th column of the U matrix.

In the example embodiment, a ranking of parameters is performed by computing a ranking vector associated with the p well-conditioned parameters:

$$Ranking Vector = {\sum }_{i = 1}^{p} {σ}_{i}^{2} {u}_{i}^{2} . \qquad ( 8 )$$

The order of the components in the ranking vector indicates the ranking of the parameter associated with each component. For example, if the third component in the ranking vector is the largest, then the parameter associated with the third row of the trajectory sensitivities matrix has the strongest impacts on model response.

In the exemplary embodiment, steps 310, 320, 330, and 340 identifies and ranks a subset of singular values, σᵢ to σₚ, for the given disturbance, i.e., which parameters have significant impacts on the output of the model for this one disturbance, but does not identify which of those are independent, i.e., which well-conditioned parameters are independent of other parameters. In steps 350 and 360, the p well-conditioned parameters are analyzed relative to each other for dependencies.

In step 350, in the exemplary embodiment, the p well-conditioned parameters are classified based on their dependencies in relation to each other. Vector angles are computed between pairs of the p well-conditioned parameters. In some embodiments, the vector angle between a pair of parameters is used as a dependence value, i.e., a quantity describing how dependent the two parameters are on each other. More specifically, each pairing of two of the p well-conditioned parameters, for example parameter i and parameter j, are identified. A vector angle between the sensitivity vectors, Sᵢ and Sⱼ, of the two parameters i and j is computed:

$$vector angle = {cos}^{- 1} ( \frac{\vert {S}_{i}^{T} {S}_{j} \vert}{‖ {S}_{i} ‖ \cdot ‖ {S}_{j} ‖} ) . \qquad ( 9 )$$

If the vector angle between parameters i and j is near 90°, then they are almost orthogonal with each other, which indicates that their impacts on model response are qualitatively different from each other, i.e., they are linearly independent of each other. If the vector angle between parameters i and j is near 0°, then their impacts on model response are qualitatively similar to each other, i.e., they are linearly dependent parameters. In some embodiments, the threshold vector angle for independency is 70°.

In the exemplary embodiment, each pairing of the p well-conditioned parameters is analyzed, and a subsequent vector angle between the pairing is computed. In step 360, the set of p well-conditioned parameters for a given disturbance may be reduced down to a set of q well-conditioned and independent parameters based on the vector angles computed between the p well-conditioned parameter pairs.

After step 360, a set of q well-conditioned and independent parameters have been identified for the given scenario. In some embodiments, additional scenarios are analyzed using the same process, each scenario generating a set of well-conditioned and independent parameters. At step 370, after many sets of well-conditioned and independent parameters qₖ have been identified for a plurality of k scenarios, a superset of well-conditioned and independent parameters, Q, are formed from the individual scenario results. For example, presume a first scenario identified 4 well-conditioned and independent parameters, but 10 total well-conditioned and independent parameters are desired. More scenarios may be analyzed until a set of at least 10 are identified. In some embodiments, more than the desired number may be computed, and then the most well-conditioned and most independent parameters may be chosen. This superset of Q well-conditioned and independent parameters represents the most influential parameters on the model, and thus the parameters that an operator may want to use during later model tuning operations.

Further, in some embodiments, at step 380, the set of disturbances is identified. An individual disturbance is valued based on the number and quality of well-conditioned and independent parameters generated in the above process. Disturbances that have a greater number of well-conditioned and independent parameters are valued higher, as they provide scenarios through which parameter tuning may be more efficiently performed. For example, in some power systems, there may be hundreds of disturbances, and the system model may have hundreds of parameters that may be tuned. Identifying disturbances with higher numbers of well-conditioned and independent parameters, i.e., over the other disturbances, assists later model tuning by identifying scenarios that increase the chance of exciting more parameters, and thus provide better venues for parameter tuning.

In addition, in some embodiments, at step 390, information about key data samples from the sets of data samples are identified as a byproduct of the parameter conditioning and ranking. During later operations such as, for example, parameter estimation optimization, a matrix of data samples may be used, which may have a number of redundancies in the data values. The matrix V, i.e., from the SVD decomposition of S_{y}, has information about what are the significant data samples in the large set of data samples, e.g., the right singular vector for the largest singular value, i.e., the left-most column of V. For example, out of 600 samples, perhaps 100 samples are identified as the most influential, i.e., the best to use during their computations. These may be used in lieu of the full set of 600 to reduce the computational burden during minimization of the least square error.

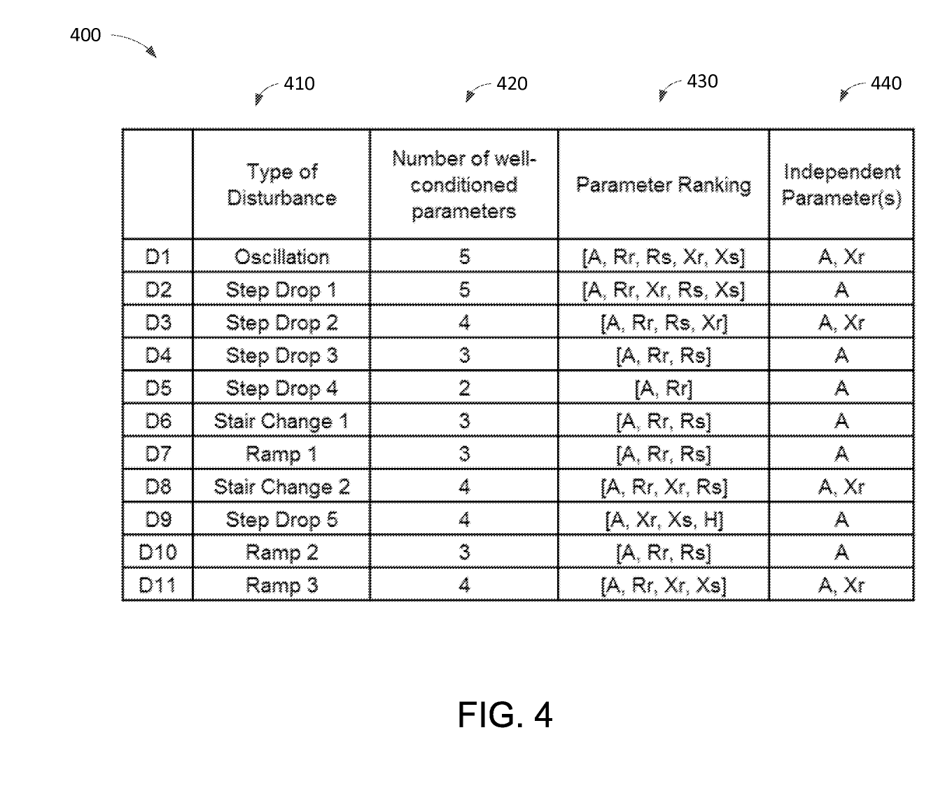

FIG. 4 is a table 400 of exemplary simulation results using the analysis method 300 shown in FIG. 3 and computing system 120 (shown in FIG. 2). The exemplary simulation analyzes a plurality of disturbances, D1-D11. Each disturbance scenario shows a disturbance explanation 410 describing the type of disturbance that was used to compute the output of the particular row. A number of well-conditioned parameters 420 is shown for each disturbance. This represents the set of p well-conditioned parameters identified as described above in reference to FIG. 3 for the given disturbance. Parameter rankings 430 is an ordered list of parameters that shows the order in which each of the well-conditioned parameters are ranked, with the most influential of the well-conditioned parameters first and the least influential of the well-conditioned parameters last. Independent parameters 440 is a list showing those parameters that are significantly independent of each other under the given scenario. In some embodiments, independent parameters 440 are substantially linearly independent of each other.

In the exemplary simulation analysis, a single-machine system, such as a 3-phase induction motor, is modeled, simulated, and analyzed. The system is modeled using the following set of differential-algebraic equations:

$$\begin{matrix}\frac{d {ω}_{*}}{d t} = - \frac{1}{2 H} [ ( A {ω}_{*}^{2} + B {ω}_{*} + C ) {T}_{0} - ( {E}_{d}^{′} {I}_{d} + {E}_{q}^{′} {I}_{q} ) ] , & ( 10 ) \\ \frac{d {E}_{q}^{′}}{d t} = - \frac{1}{{T}^{′}} [ {E}_{q}^{′} - ( X - {X}^{′} ) {I}_{d} ] + ( {ω}_{*} - 1 ) {E}_{d}^{′} , & ( 11 ) \\ \frac{d {E}_{d}^{′}}{d t} = - \frac{1}{{T}^{′}} [ {E}_{d}^{′} - ( X - {X}^{′} ) {I}_{q} ] + ( {ω}_{*} - 1 ) {E}_{q}^{′} , & ( 12 ) \\ {I}_{d} = \frac{1}{{R}_{S}^{2} + {X}^{′ 2}} [ {R}_{S} ( {U}_{d} - {E}_{d}^{′} ) + {X}^{′} ( {U}_{q} - {E}_{q}^{′} ) ] , & ( 13 ) \\ {I}_{q} = \frac{1}{{R}_{S}^{2} + {X}^{′ 2}} [ {R}_{S} ( {U}_{q} - {E}_{q}^{′} ) + {X}^{′} ( {U}_{d} - {E}_{d}^{′} ) ] , & ( 14 ) \\ P = {I}_{d} {U}_{d} + {I}_{q} {U}_{q} , & ( 15 ) \\ Q = {I}_{d} {U}_{q} - {I}_{q} {U}_{d} , & ( 16 )\end{matrix}$$

where equations (10), (11), and (12) represent 3 dynamic states of the single-machine system, and equations (13), (14), (15), and (16) represent 4 algebraic states of the system, where P, I, and Z represent the constant power, constant current, and constant impedance of the system, respectively. The parameters of the system are the stator winding resistance (R_{S}), the stator leakage reactance (X_{S}), the magnetizing reactance (Xₘ), the rotor resistance (Rᵣ), and the rotor leakage reactance (Xᵣ). Additionally:

$$\begin{matrix}{T}^{′} = \frac{( {X}_{r} + {X}_{m} )}{{R}_{r}} , & ( 17 ) \\ X = {X}_{s} + {X}_{m} , & ( 18 ) \\ {X}^{′} = {X}_{s} + \frac{( {X}_{m} {X}_{r} )}{{X}_{m} + {X}_{r}} , & ( 19 )\end{matrix}$$

and H is the rotor inertia constant, and A, B, and C, respectively, are the torque coefficient in proportion to the square of the speed, that in proportion to the speed and to the constant torque coefficient irrelevant to the speed, which satisfy A+B+C=1. Further, w is the per unit value of the rotation speed of the induction motor, E_{d}′ and E_{q}′ refer to the d-axis and q-axis transient EMF of the induction motor, U_{d} and U_{g} refer to the d-axis and q-axis bus voltage, while I_{d} and I_{g} represent the d-axis and the q-axis stator currents, and T₀ is the nominal torque at the nominal rotation speed.

Further, in the exemplary embodiment, each disturbance D1-D11 is analyzed individually to determine an associated number of well-conditioned parameters 420. For example, disturbance D5 is analyzed as described above in reference to FIG. 3. Two well-conditioned parameters 420, A and Rᵣ, are identified for disturbance D5. After ranking the two well-conditioned parameters 420 for D5, an ordered list shows a ranking 430 of the two parameters, with A listed as the most well-conditioned parameter of the two. During dependency analysis, the process analyzes only one combination pairing of well-conditioned parameters because there are only two well-conditioned parameters. It is determined that parameters A and Rᵣ are dependent parameters, and thus A is listed as the only independent parameter. Disturbance D5, thus, represents a less-useful disturbance, as it includes only two well-conditioned parameters, and Rᵣ is dependent upon A.

Similarly, in the exemplary embodiment, disturbance D1 is analyzed as described above in reference to FIG. 3. Five well-conditioned parameters 420, A, Rᵣ, R_{S}, Xᵣ, and Xₛ, are identified for disturbance D1. After ranking the five well-conditioned parameters 420 for D1, an ordered list shows a ranking 430 of the two parameters, with A listed as the most well-conditioned parameter of the five. During dependency analysis, the process analyzes each combination pairing of well-conditioned parameters. It is determined, in the example embodiment, that parameters A and Xᵣ are independent parameters 440 based on disturbance D1. Disturbance D1, thus, represents a more useful disturbance relative to some of the other disturbances, as it includes five well-conditioned parameters, two of which are substantially independent of each other.

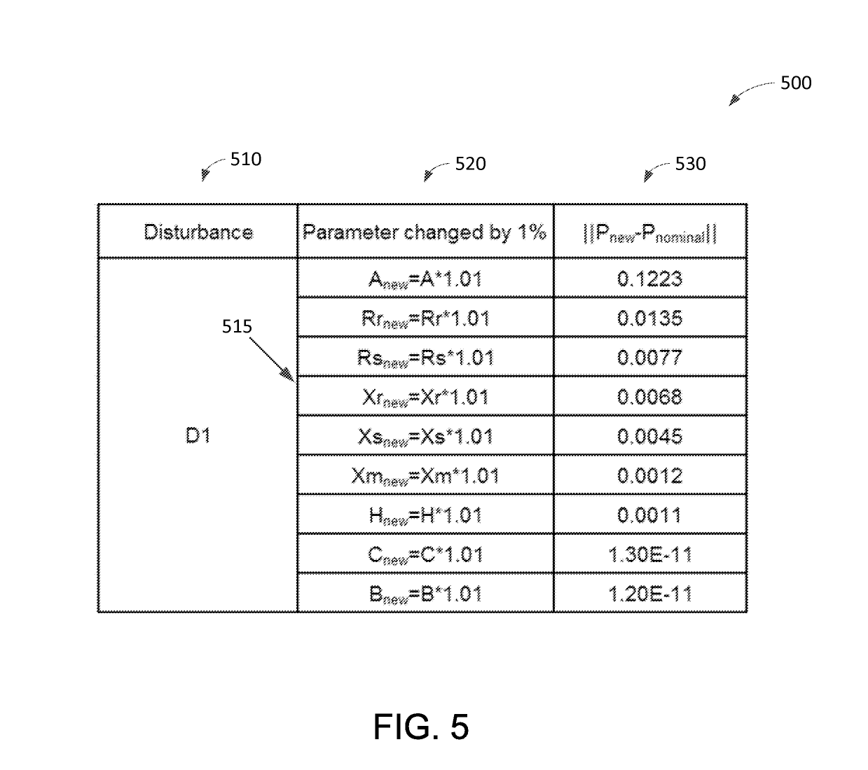

FIG. 5 is a table 500 showing algorithm validation results for disturbance D1 shown in FIG. 4. In the exemplary embodiment, table 500 demonstrates the effectiveness of these systems and methods when ranking each disturbance based on number of well-conditioned parameters 420 and independencies between parameters 440 (shown in FIG. 4). Table 500 includes the disturbance identifier 510. The disturbance 510 shown includes a set of rows 515, and in each row 515 is a parameter change 520 and an associated norm value 530 for each parameter identified for the disturbance 510, including the five well-conditioned parameters 420 identified in FIG. 4. Parameter change 520 computes a slight value change for the parameter, and norm value 530 is the associated change computed in the output value when the new parameter change 520 value is used.

For example, for disturbance D1, the starting value of parameter A, i.e., the original nominal value of A, is changed by 1% to generate an A_{new}=A*1.01. A_{new} is then used as the starting value for the model, and disturbance D1 is again simulated to generate a new output, P_{new}. The difference between the nominal output with the original starting value of A, i.e., Pₙₒₘᵢₙₐₗ and the output of the model simulation with the altered value of A_{new}, i.e., P_{new}, is computed as 0.1223. By perturbating the parameter by a small amount and computing the resulting change in model response, the significance of that parameter is quantified. Similarly, the other parameters of D1 are also analyzed with the same small parameter change to generate corresponding norm values 530. As such, disturbances may be compared against each other.

Norms of the difference between nominal active power and active power after parameter modification by 1% were computed. FIG. 5 indicates that the systems and methods described herein successfully rank the parameters and find the number of well-conditioned parameters. Parameter B and C are equal to zero in IEEE Type 6 motors, and as such, they are changed to a small, non-zero quantity so that their percentage-wise change may be in effect. The independence between parameters means that the effect in model response caused by the two parameters is qualitatively different. In other words, model response modification caused by the change of dependent parameters may be almost identical with each other, but the model response caused by change of the independent parameters differs.

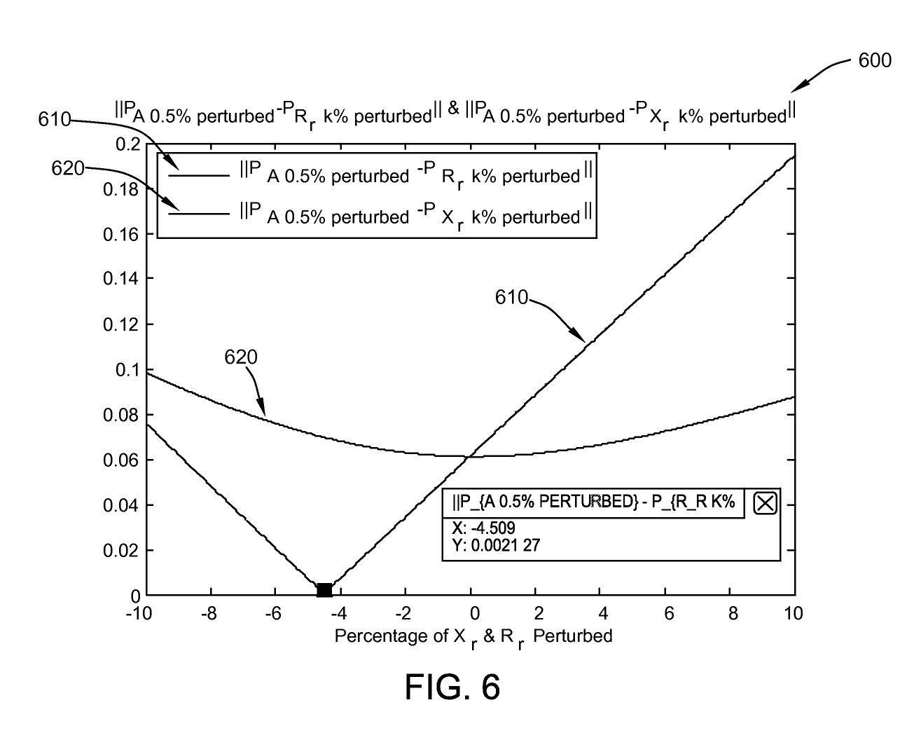

FIG. 6 is an exemplary graph 600 showing a comparison of the norm of difference between active powers when altering independent variables and the norm of difference between active powers when altering parameters under disturbance D1 as shown in FIGS. 4 and 5. A first plot 610 shows the norm of difference between active power with parameter A changed by 0.5% and Rᵣ changed from −10% to +10%, i.e., with Rᵣ as the X-axis variable. A second plot 620 shows the norm of difference between active power with parameter A changed by 0.5% and Xᵣ changed from −10% to +10%, i.e., with Xᵣ as the X-axis variable. Note, from table 1 above, that A and Xᵣ were determined to be independent of each other, while A and Rᵣ were determined to be dependent parameters. Graph 600 indicates that the active power change from the modification of parameter A by 0.5% is almost equal to the active power change from the modification of parameter Rᵣ by −4.509%. In other words, the model response change from the modification of parameter Rᵣ by −4.509% may also be achieved by the modification of parameter A by 0.5%, i.e., at the inflection point of first plot 610 at approximately where first plot 610 intersects the X-axis. However, this cannot be achieved between independent parameters, i.e., second plot 620 maintains a certain distance from the X-axis. Thus, the number of independent parameters is also important to select disturbance for load model parameter estimation. If the number of independent parameters is small, the degree of freedom to change the model response in qualitative sense is small. If, however, the number of independent parameters is large, the model response may be closely shaped to actual response with higher degrees of freedom.

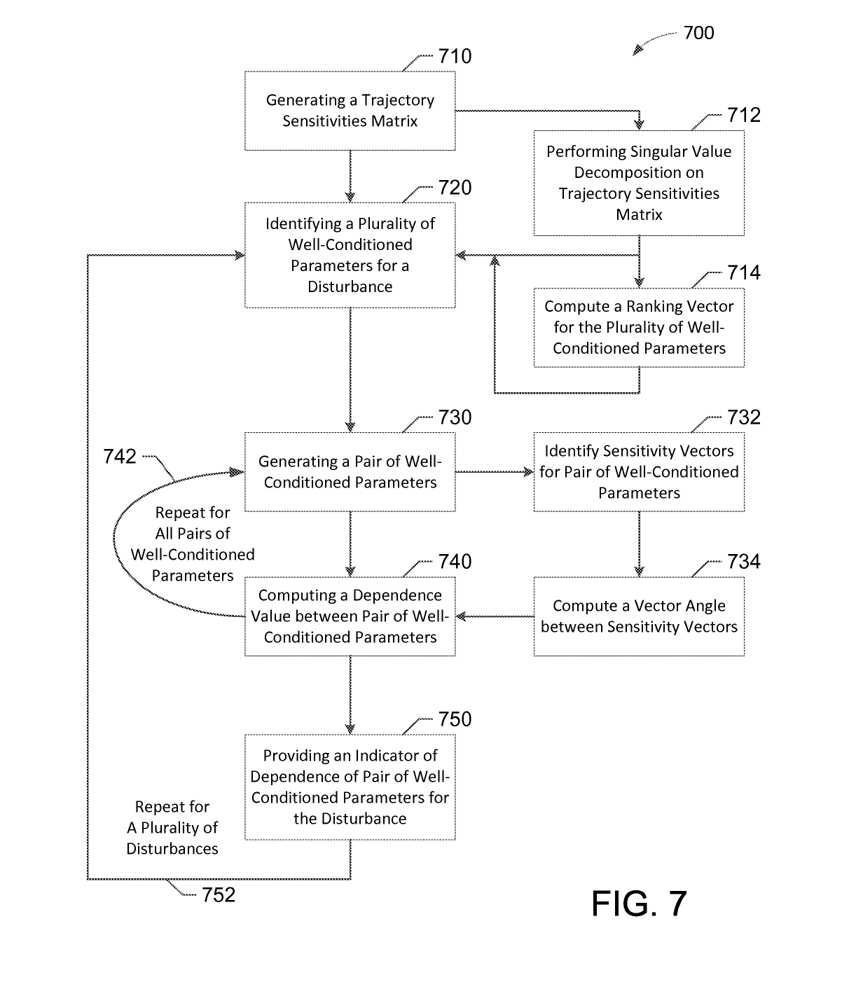

FIG. 7 is a flow chart of an exemplary method 700 analyzing system parameters of a simulation model for transmission system 103 (shown in FIG. 1) using computing system 120 (shown in FIG. 2). In the exemplary embodiment, method 700 includes generating 710 a trajectory sensitivities matrix for the electrical power transmission system 103 using at least a dynamic model of the system 103 that includes a plurality of system parameters. Method 700 also includes identifying 720 a plurality of well-conditioned parameters for a first disturbance from the plurality of system parameters based at least in part on the trajectory sensitivities matrix. In some embodiments, method 700 includes performing 712 singular value decomposition on the trajectory sensitivities matrix, thereby generating a plurality of singular values. Each singular value of the plurality of singular values is associated with a system parameter of the plurality of system parameters. Further, identifying 720 the plurality of well-conditioned parameters from the plurality of system parameters based at least in part on the plurality of singular values. Further, in some embodiments, method 700 includes computing 714 a ranking vector using the plurality of singular values and the plurality of associated left singular vectors.

Also in the exemplary embodiment, method 700 includes generating 730 a first pair of well-conditioned parameters from the plurality of well-conditioned parameters. The first pair includes a first parameter and a second parameter. Method 700 also includes computing 740 a dependence value between the first parameter and the second parameter. In some embodiments, the dependence value is a linear dependence value. Further, in some embodiments, method 700 includes identifying 732, from the trajectory sensitivities matrix, a first sensitivity vector for the first parameter and a second sensitivity vector for the second parameter, and computing 734, by the at least one processor, a vector angle between the first sensitivity vector and the second sensitivity vector. Further, in some embodiments, method 700 includes providing 750 the indicator of dependence of the first pair of well-conditioned parameters for the first disturbance based on the vector angle. In some embodiments, method 700 includes repeating 742 generation of pairs of well-conditioned parameters, and corresponding dependence values of each pair.

Further, in the exemplary embodiment, method 700 includes providing an indicator of dependence of the first pair of well-conditioned parameters for the disturbance using the dependence value. In some embodiments, some or all of method 700 steps are repeated 752 for a plurality of disturbances. As such, method 700 may include identifying one or more pairs of well-conditioned parameters for a plurality of disturbances, computing an indicator of dependence of each pair of well-conditioned parameters of the one or more pairs of well-conditioned parameters for the plurality of disturbances, and providing a relative ranking of the plurality of disturbances, wherein the ranking is based at least in part on the effectiveness of each disturbance of the plurality of disturbances on analyzing system parameters of the simulation model.

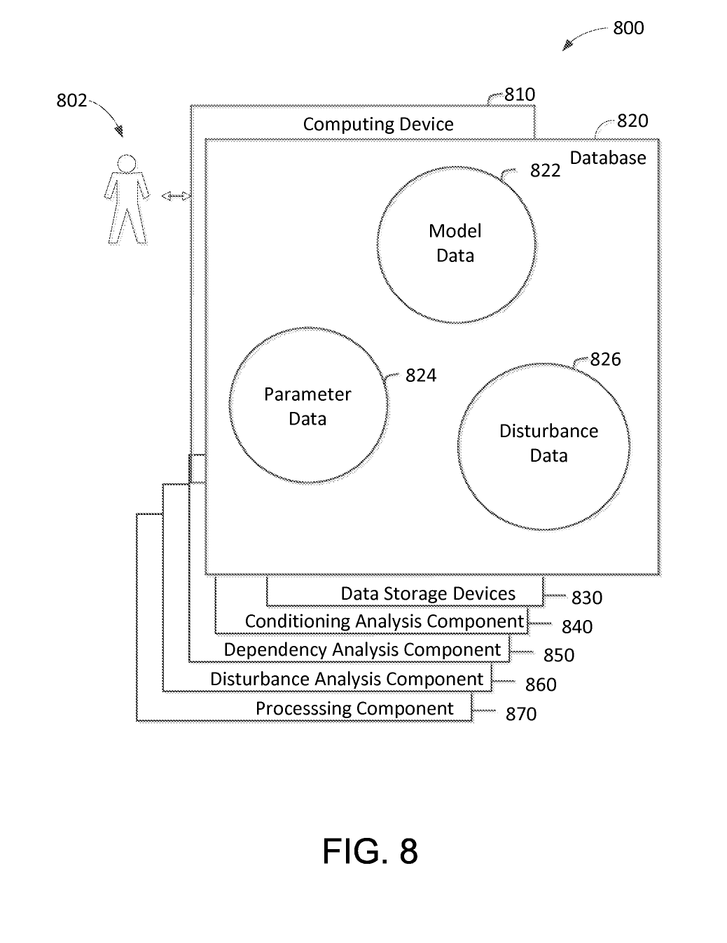

FIG. 8 illustrates an example configuration 800 of a database 820 within a computing device 810, along with other related computing components, that may be used during analysis of model parameters as described herein. Database 820 is coupled to several separate components within computing device 810, which perform specific tasks. In the example embodiment, computing device 810 may be computing system 120 (shown in FIGS. 2 and 3).

In the example embodiment, database 820 includes model data 822, disturbance data 824, and parameter data 826. Model data 822 includes information associated with the mathematical models used to simulate actions and reactions of the transmission network 103. Disturbance data 824 includes information associated with disturbances that could or have occurred on the transmission network 103, such as disturbances D1-D11 (shown in FIG. 4), and may include historical sample data during such disturbances. Parameter data 826 includes information associated with parameters that are used with model data 822 and disturbance data 824 for simulating transmission network 103.

Computing device 810 includes the database 820, as well as data storage devices 830. Computing device 810 also includes a conditioning analysis component 840 for operations such as determining well-conditioned parameters using model data 822, disturbance data 824, and parameter data 826. Computing device 810 also includes an dependence analysis component 850 for operations such as determining dependencies between parameters during simulation of disturbances. A disturbance analysis component 860 is also included for operations such as identifying and ranking disturbances. A processing component 870 assists with execution of computer-executable instructions associated with the system.

The embodiments illustrated and described herein, as well as embodiments not specifically described herein, but, within the scope of aspects of the disclosure, constitute exemplary means for analyzing model parameters of electrical power transmission systems using trajectory sensitivities. For example, computing system 120, and any other similar computer device added thereto or included within, when integrated together, include sufficient computer-readable storage media that is/are programmed with sufficient computer-executable instructions to execute processes and techniques with a processor as described herein. Specifically, computing system 120 and any other similar computer device added thereto or included within, when integrated together, constitute an exemplary means for analyzing model parameters of electrical power transmission systems using trajectory sensitivities.

The above-described systems and methods provide a way to analyze model parameters of electrical power transmission systems using trajectory sensitivities. Electrical power transmission systems are simulated using models, and these models, to perform most effectively, should be adjusted to closely replicate actual values. The embodiments described herein allow for identification of the most influential parameters of the model for a given disturbance, and for identification of more applicable disturbances to use during model tuning and analysis. For a particular disturbance, a number of well-conditioned parameters are identified using trajectory sensitivities. From this set of well-conditioned parameters, a subset of linearly independent parameters is identified by computing vector angles between the sensitivity vectors for particular pairs of parameters, thereby identifying a subset of well-conditioned and linearly independent parameters for the disturbance. Further, a plurality of disturbances is analyzed as such. Disturbances are then ranked and/or valued based on the number of well-conditioned parameters and the independence of the well-conditioned parameters, thereby identifying disturbances that provide improved parameter tuning analysis potential.

An exemplary technical effect of the methods, systems, and apparatus described herein includes at least one of: (a) identifying well-conditioned parameters within a model of an electric power transmission network; (b) identifying dependence relations between parameters; (c) identifying sets of well-conditioned and linearly independent parameters for one or more disturbances; (d) determining analytical value and/or ranking of a plurality of disturbances with regard to parameter tuning; and (e) identifying key data samples for later analytical use.

Exemplary embodiments of systems and methods for analyze model parameters of electrical power transmission systems using trajectory sensitivities are described above in detail. The systems and methods described herein are not limited to the specific embodiments described herein, but rather, components of systems and/or steps of the methods may be utilized independently and separately from other components and/or steps described herein. For example, the methods may also be used in combination with other systems involving analysis of data streams, and are not limited to practice with only the transmissions systems and methods as described herein. Rather, the exemplary embodiments can be implemented and utilized in connection with many other model parameter analysis applications.

Although specific features of various embodiments may be shown in some drawings and not in others, this is for convenience only. In accordance with the principles of the systems and methods described herein, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer system for analyzing system parameters of a simulation model for an electrical power system, said computer system comprising a processor programmed to:
generate a trajectory sensitivities matrix for the electrical power system using a dynamic model of the electrical power system that includes a plurality of system parameters;
identify a plurality of well-conditioned parameters for a first disturbance from the plurality of system parameters based at least in part on the trajectory sensitivities matrix;
generate a first pair of well-conditioned parameters from the plurality of well-conditioned parameters, the first pair including a first parameter and a second parameter;
compute a dependence value between the first parameter and the second parameter; and
provide an indicator of dependence between the first parameter and the second parameter using the dependence value.

2. The computer system of claim 1, wherein the processor is further programmed to:
perform singular value decomposition on the trajectory sensitivities matrix, thereby generating a plurality of singular values; and
identify the plurality of well-conditioned parameters from the plurality of system parameters based at least in part on the plurality of singular values.

3. The computer system of claim 2, wherein the processor is further programmed to:
identify a singular value and a corresponding left singular vector for each singular value, thereby identifying a plurality of singular values and a plurality of associated left singular vectors; and
compute a ranking vector using the plurality of singular values and the plurality of associated left singular vectors, the ranking vector indicating the ranking of each parameter in the plurality of well-conditioned parameters.

4. The computer system of claim 1, wherein the processor is further programmed to:
identify, from the trajectory sensitivities matrix, a first sensitivity vector for the first parameter and a second sensitivity vector for the second parameter;
compute a vector angle between the first sensitivity vector and the second sensitivity vector; and
provide the indicator of dependence of the first pair of well-conditioned parameters for the first disturbance based on the vector angle.

5. The computer system of claim 1, wherein the processor is further programmed to:
generate a plurality of unique pairs of well-conditioned parameters from the plurality of well-conditioned parameters;
compute a dependence value for each unique pair of well-conditioned parameters of the plurality of well-conditioned parameters, thereby generating a plurality of dependence values; and
provide an indicator of dependence for each unique pair of well-conditioned parameters using the plurality of dependence values.

6. The computer system of claim 1, wherein the processor is further programmed to:
identify one or more pairs of well-conditioned parameters for a plurality of disturbances;
compute an indicator of dependence of each pair of well-conditioned parameters of the one or more pairs of well-conditioned parameters for the plurality of disturbances; and
provide a relative ranking of the plurality of disturbances, wherein the ranking is based at least in part on the effectiveness of each disturbance of the plurality of disturbances on analyzing system parameters of the simulation model.

7. The computer system of claim 1, wherein the processor is further programmed to:
perform singular value decomposition on the trajectory sensitivities matrix, thereby generating a plurality of singular values; and
identify a subset of data samples from a plurality of data samples associated with the first disturbance based at least in part on a singular value of the plurality of singular values and an associated right singular vector.

8. At least one non-transitory computer-readable storage media having computer-executable instructions embodied thereon, wherein when executed by at least one processor, the computer-executable instructions cause the processor to:
generate a trajectory sensitivities matrix for an electrical power system using a dynamic model of the electrical power system that includes a plurality of system parameters;
identify a plurality of well-conditioned parameters for a first disturbance from the plurality of system parameters based at least in part on the trajectory sensitivities matrix;
generate a first pair of well-conditioned parameters from the plurality of well-conditioned parameters, the first pair including a first parameter and a second parameter;
compute a dependence value between the first parameter and the second parameter; and
provide an indicator of dependence between the first parameter and the second parameter using the dependence value.

9. The computer-readable storage media of claim 8, wherein the computer-executable instructions further cause the processor to:
perform singular value decomposition on the trajectory sensitivities matrix, thereby generating a plurality of singular values; and
identify the plurality of well-conditioned parameters from the plurality of system parameters based at least in part on the plurality of singular values.

10. The computer-readable storage media of claim 9, wherein the computer-executable instructions further cause the processor to:
identify a singular value and a left singular vector for each well-conditioned parameter of the plurality of well-conditioned parameters, thereby identifying a plurality of singular values and a plurality of associated left singular vectors; and
compute a ranking vector using the plurality of singular values and the plurality of associated left singular vectors, the ranking vector indicating the ranking of each parameter in the plurality of well-conditioned parameters.

11. The computer-readable storage media of claim 8, wherein the computer-executable instructions further cause the processor to:
identify, from the trajectory sensitivities matrix, a first sensitivity vector for the first parameter and a second sensitivity vector for the second parameter;
compute a vector angle between the first sensitivity vector and the second sensitivity vector; and
provide the indicator of dependence of the first pair of well-conditioned parameters for the first disturbance based on the vector angle.

12. The computer-readable storage media of claim 8, wherein the computer-executable instructions further cause the processor to:
generate a plurality of unique pairs of well-conditioned parameters from the plurality of well-conditioned parameters;
compute a dependence value for each unique pair of well-conditioned parameters of the plurality of well-conditioned parameters, thereby generating a plurality of dependence values; and
provide an indicator of dependence for each unique pair of well-conditioned parameters using the plurality of dependence values.

13. The computer-readable storage media of claim 8, wherein the computer-executable instructions further cause the processor to:
identify one or more pairs of well-conditioned parameters for a plurality of disturbances;
compute an indicator of dependence of each pair of well-conditioned parameters of the one or more pairs of well-conditioned parameters for the plurality of disturbances; and
provide a relative ranking of the plurality of disturbances, wherein the ranking is based at least in part on the effectiveness of each disturbance of the plurality of disturbances on analyzing system parameters of the simulation model.

14. A computer-based method for analyzing system parameters of a simulation model for an electrical power system using a computing device including at least one processor, said method comprising:
generating a trajectory sensitivities matrix for the electrical power system using a dynamic model of the electrical power system that includes a plurality of system parameters;
identifying, by the at least one processor, a plurality of well-conditioned parameters for a first disturbance from the plurality of system parameters based at least in part on the trajectory sensitivities matrix;
generating, by the at least one processor, a first pair of well-conditioned parameters from the plurality of well-conditioned parameters, the first pair including a first parameter and a second parameter;
computing, by the at least one processor, a dependence value between the first parameter and the second parameter; and
providing an indicator of dependence between the first parameter and the second parameter using the dependence value.

15. The method in accordance with claim 14 further comprising:
performing singular value decomposition on the trajectory sensitivities matrix, thereby generating a plurality of singular values; and
identifying the plurality of well-conditioned parameters from the plurality of system parameters based at least in part on the plurality of singular values.

16. The method in accordance with claim 15 further comprising:
identifying a singular value and a left singular vector for each well-conditioned parameter of the plurality of well-conditioned parameters, thereby identifying a plurality of singular values and a plurality of associated left singular vectors; and
computing a ranking vector using the plurality of singular values and the plurality of associated left singular vectors, the ranking vector indicating the ranking of each parameter in the plurality of well-conditioned parameters.

17. The method in accordance with claim 14 further comprising:
identifying, from the trajectory sensitivities matrix, a first sensitivity vector for the first parameter and a second sensitivity vector for the second parameter;
computing, by the at least one processor, a vector angle between the first sensitivity vector and the second sensitivity vector; and
providing the indicator of dependence of the first pair of well-conditioned parameters for the first disturbance based on the vector angle.

18. The method in accordance with claim 14 further comprising:
generating a plurality of unique pairs of well-conditioned parameters from the plurality of well-conditioned parameters;
computing a dependence value for each unique pair of well-conditioned parameters of the plurality of well-conditioned parameters, thereby generating a plurality of dependence values; and
providing an indicator of dependence for each unique pair of well-conditioned parameters using the plurality of dependence values.

19. The method in accordance with claim 14 further comprising:
identifying one or more pairs of well-conditioned parameters for a plurality of disturbances;
computing, by the at least one processor, an indicator of dependence of each pair of well-conditioned parameters of the one or more pairs of well-conditioned parameters for the plurality of disturbances; and
providing a relative ranking of the plurality of disturbances, wherein the ranking is based at least in part on the effectiveness of each disturbance of the plurality of disturbances on analyzing system parameters of the simulation model.

20. The method in accordance with claim 14 further comprising:
performing singular value decomposition on the trajectory sensitivities matrix, thereby generating a plurality of singular values; and
identifying a subset of data samples from a plurality of data samples associated with the first disturbance based at least in part on a singular value of the plurality of singular values and an associated right singular vector.
